(19) United States
(12) Patent Application Publication
(10) Pub. No.: US 2016/0059684 A1
(43) Pub. Date: Mar. 3, 2016

(54) DOOR FRAME AND MOLDING DEVICE FOR VEHICLE

(71) Applicant: Hyundai Motor Company, Seoul (KR)

(72) Inventor: Yong Hyun NAM, Gunpo-Si (KR)

(73) Assignee: Hyundai Motor Company, Seoul (KR)

(21) Appl. No.: 14/570,715

(22) Filed: Dec. 15, 2014

(30) Foreign Application Priority Data
Aug. 28, 2014 (KR) 10-2014-0112856

(51) Int. Cl. B60J 10/08; B60J 10/00

(52) U.S. Cl. CPC B60J 10/088; B60J 10/0002; B60J 10/002; B60J 10/0048; B60J 10/0062; B60J 10/08

(57) ABSTRACT

An automotive door molding device, may include a door frame composed of an inner support formed with a space therein by foaming, a connection support extending from an outer upper end of the inner support and horizontally arranged, and a variable frame molding support vertically bending upward from an outer end of the connection support, an integral weather strip disposed on the inner support and the connection support of the door frame, a run channel having an inner glass run supporting an inner side of a glass and disposed on an outer side and a bottom of the inner support of the door frame, and a variable frame molding fastened to a bottom of the connection support, in close contact with the variable frame molding support of the door frame.

### CROSS-REFERENCE TO RELATED APPLICATION

The present application claims priority to Korean Patent Application No. 10-2014-0112856 filed Aug. 28, 2014, the entire contents of which is incorporated herein for all purposes by this reference.

### BACKGROUND OF THE INVENTION

1. Field of the Invention

The present disclosure relates to an automotive door frame molding device. More particularly, it relates to an automotive door molding device that allows for improvement of assembly quality and reduction of the manufacturing cost by improving the assembly cross-sectional structure between a door frame and a variable frame molding.

2. Description of Related Art

A variable frame molding 50, of which the vertical width changes, as it goes in the longitudinal direction of a car body, is mounted, as a kind of external ornament, on the outer side of a door frame being in contact with the top of door glasses of a vehicle, as illustrated in FIG. 1A, FIG. 1B, FIG. 2A and FIG. 2B.

Parts for waterproofing and airtightness, including parts for supporting the variable frame molding, are compactly assembled inside the door frame.

Hereinafter, the configuration of a door frame molding device of the related art is described.

FIG. 1A, FIG. 1B, FIG. 2A and FIG. 2B illustrate a door frame molding device of the related art, in which FIG. 1 is a cross-sectional view taken along line A-A and FIG. 2 is a cross-sectional view taken along line B-B.

In FIG. 1A, FIG. 1B, FIG. 2A and FIG. 2B, the reference numeral ‘10’ indicates a door frame of the related art.

The door frame 10 of the related art, which is manufactured by bending of folding a sheet of frame in a single unit having a predetermined shape with a roll mold, is composed of an inner support 12 formed with a space therein by foaming, a variable frame molding coupling portion 16 disposed on the outer side of a car body, and a connection support 14 bending twice and integrally connecting the inner support 12 and the variable molding coupling portion 16.

The variable frame molding coupling portion 16 and the connection support 14 make a T-shaped cross-section.

First bending portions 12-1 are formed at the inner and outer ends of the top of the inner support 12 of the door frame 10 to form a groove in which a weather strip is fitted and second bending portions 12-2 are formed at the upper end and the lower end of the outer side of the inner support 12 to form a groove in which a run channel is fitted.

The connection support 14, which is formed by folding a sheet of frame flat, is composed of a first connecting portion 14-1 primarily bending at an angle upward from the first bending portion 12-1 of the inner support 12 and a second connecting portion 14-2 secondarily bending in the width direction of a car body from the first connecting portion 14-1 to form a flat plate structure.

The variable frame molding coupling portion 16 has a flat plate-shaped structure in the up-down direction, perpendicular to the second connecting portion 14-2 of the connection support 14 and makes a T-shaped cross-section in cooperation with the second connecting portion 14-2 of the connection support 14.

The first connecting portion 14-1 and the second connecting portion 14-2 of the connection support 14 and the variable frame molding coupling portion 16 make a fitting groove having an inverse U-shaped cross-section so that a run channel 30 is fitted therein.

A door weather strip 20 for waterproofing and airtightness, the run channel 30 in which the top of a door glass 80 is inserted without a shock when it is moved up, a parting weather strip 40 for waterproofing and airtightness in contact with a car body panel 70 (for example, a roof panel and a side outer panel) being in contact with the door frame, and a variable frame molding 50 that is a kind of external ornament are compactly mounted on the door frame 10.

The door weather strip 20 is fastened with the lower end fitted in the groove formed by the first bending portions 12-1 of the inner support 12.

The run channel 30 is fastened with the upper end fitted in the inverse U-shaped fitting groove formed by the first connecting portion 14-1 and the second connecting portion 14-2 of the connection support 14 and the variable frame molding coupling portion 16 and with the inner lower end supported on the second bending portion 12-2 of the inner support 12.

An inner glass run 31 and an outer glass run 32 which are in close contact with in and out of the glass 80 are integrally formed at the lower end of the run channel 30.

The parting weather strip 40 has a hollow body 41, an inner support end 42 integrally formed on the inner side of the hollow body 41 and extending downward toward the door weather strip 20, an outer support end 43 extending upward from the upper end of the outer side of the body 41 and supported in close contact with the car body panel 70, and a support groove 44 formed at the lower end on the outer side of the body 41.

The variable frame molding 50 is composed of an insert injection-molded body 51 and an ornament frame 52 (for example, an SUS plate) injection-molded integrally on the outer side of the insert injection-molded body 51, and is mounted to cover the outer side of the variable molding coupling portion 16.

In more detail, the inner side of the variable frame molding 50 and the variable molding coupling portion 16 are bonded by a bonding member 53 (for example, a double-sided bonding tape), with the upper end of the variable frame molding 50 fitted and supported in a support groove 44 of the parting weather strip 40 and the lower end fitted and supported in the outer side of the run channel 30.

On the other hand, a mounting molding 60 for allowing the vertical width of the variable molding frame to change is disposed between the body 41 of the parting weather strip 40 and the second connecting portion 14-2 of the connection support 14 of the door frame 10.

That is, the vertical width of the variable frame molding 50 increases, as it goes rearward, so the vertical width of the mounting molding 60 also gradually increases, as it goes rearward.

Accordingly, a double-sided tape 62 is attached to the top of the second connecting portion 14-2 of the connection support 14 and then the mounting molding 60 is attached thereon such that the mounting molding 60 supports the body 41 of the parting weather strip 40.

The variable frame molding 50 is manufactured such that the vertical width gradually increases in the longitudinal direction of a car body in consideration of the external aesthetic appearance of a vehicle.

That is, when the variable frame molding 50 is manufactured, the insert injection-molded body 51 and the ornament plate 52 of the variable molding 50 are manufactured such that their vertical widths gradually increase, as they go rearward.

When the variable frame molding 50 is divided into an upper part and a lower part with the connection support 14 of the door frame 10 therebetween, as illustrated in FIG. 1A, FIG. 1B, FIG. 2A and FIG. 2B, the lower part has the same width at the front portion and the rear portion, while the upper part is actually the part of which the vertical width gradually increases, as it goes rearward.

Accordingly, as illustrated in FIG. 1A and FIG. 1B, the front portion of the mounting molding 60 has a small vertical width, including the variable frame molding 50, and as illustrated in FIG. 2A and FIG. 2B, the rear portion of the mounting molding 60, including the variable frame molding 50 has a large vertical width.

The door frame molding device of the related art described above has following problems.

First, as illustrated in FIG. 3, when a vehicle is washed with a separate sun visor 90 attached to the outer side of the variable frame molding 50 and when sprayed water applies pressure to the inside of the sun visor from under, the sun visor is turned over and the variable frame molding comes off or separates.

That is, the bonding force of the bonding tape for bonding the variable frame molding 50 and the variable molding coupling portion 16 is smaller than the water pressure applied to the sun visor in car washing, so the variable frame molding 50 comes off or separates from the variable molding coupling portion 16.

Second, in addition to the door frame, there are too many parts mounted on the door frame, so assemblage is inconvenient and the manufacturing cost increases.

That is, there are too many parts, including the door weather strip 20, the run channel 30, the parting weather strip 40, the variable frame molding 50, the mounting molding 60, the double-sided tape 62 for attaching the mounting molding 60, and the bonding member 53 for attaching the variable frame molding 50, so assemblage is inconvenient and the manufacturing cost increases.

Third, as a glass is moved up, the top of glass inserted between the inner glass run 31 and the outer glass run 32 of the run channel 30, the outer glass run 32 supported in contact with the inner side of the variable frame molding 50 is pulled up, so the supporting force that brings the outer glass run 32 in close contact with the glass 80 decreases, and accordingly, wind flows into the interior of the vehicle from the outside.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing an automotive door molding device that makes it possible to considerably decrease the number of assembly parts, improve assembly quality, and reduce the manufacturing cost by improving the design of a vertical width of a variable frame molding and by improving the assembly structure between a door frame and a variable frame molding.

According to various aspects of the present invention, an automotive door molding device may include a door frame composed of an inner support formed with a space therein by foaming, a connection support extending from an outer upper end of the inner support and horizontally arranged, and a variable frame molding support vertically bending upward from an outer end of the connection support, an integral weather strip disposed on the inner support and the connection support of the door frame, a run channel having an inner glass run supporting an inner side of a glass and disposed on an outer side and a bottom of the inner support of the door frame, and a variable frame molding fastened to a bottom of the connection support, in close contact with the variable frame molding support of the door frame.

The integral weather strip may be manufactured by forming a hollow door weather strip part being in close contact with an inner side of the car body panel with a parting weather strip part being in close contact with an outer side of the car body panel into a signal unit.

A support groove in which the upper end of the variable frame molding is inserted and supported may be formed on an outer side of the parting weather strip part of the integral weather strip.

The variable frame molding may have an upper end that is an upper part over the connection support of the door frame having a same vertical width at a front portion and a rear portion of the variable frame molding, and a lower end that is a lower part having a vertical width that increases rearward.

A fastening protrusion that is fastened by a clip in close contact with the bottom of the connection support of the door frame may be integrally formed on an inner side of the variable frame molding.

The fastening protrusion may increase in thickness, as it goes from the front portion to the rear portion, in proportion to the width of the lower end of the variable frame molding which increases, as it goes from the front portion to the rear portion.

An outer glass run supporting an outer side of a glass may be integrally formed on an inner side of a bottom of the variable frame molding.

A fitting groove in which the variable frame molding support of the door frame is fitted may be formed on an inner side of a top of the variable frame molding.

A support protrusion supporting an end of the integral weather strip may be integrally formed on a top inside the connection support.

The present invention provides the following effects from the various embodiments.

First, since the upper part of the variable frame molding over the connection support of the door frame has a constant vertical width, while the lower part has a vertical width that gradually increases, as it goes rearward, the door weather strip and the parting weather strip can be integrally formed, and accordingly, the number of parts can be reduced.

Second, since the fastening protrusion fastened to the door frame by a clip is integrally formed on the inner side of the variable frame molding, it is possible to more firmly combine the variable frame molding and prevent coming-off of a variable frame molding due to water pressure in car washing in the related art.

Third, since the outer glass run supporting the outer side of a glass is integrally formed on the inner side of the bottom of the variable frame molding, it is possible to prevent the phenomenon that an outer glass run integrally formed in a run channel from is pulled up and the supporting force that brings the outer glass run in close contact with a glass decreases.

It is understood that the term “vehicle” or “vehicular” or other similar terms as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuel derived from resources other than petroleum). As referred to herein, a hybrid vehicle is a vehicle that has two or more sources of power, for example, both gasoline-powered and electric-powered vehicles.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1A, FIG. 1B, FIG. 2A and FIG. 2B are cross-sectional views illustrating a door frame molding device of the related art.

FIG. 3 is a cross-sectional view illustrating a problem with the door frame molding device of the related art.

FIG. 4A, FIG. 4B, FIG. 5A and FIG. 5B are cross-sectional views illustrating a door frame molding device according to the present invention.

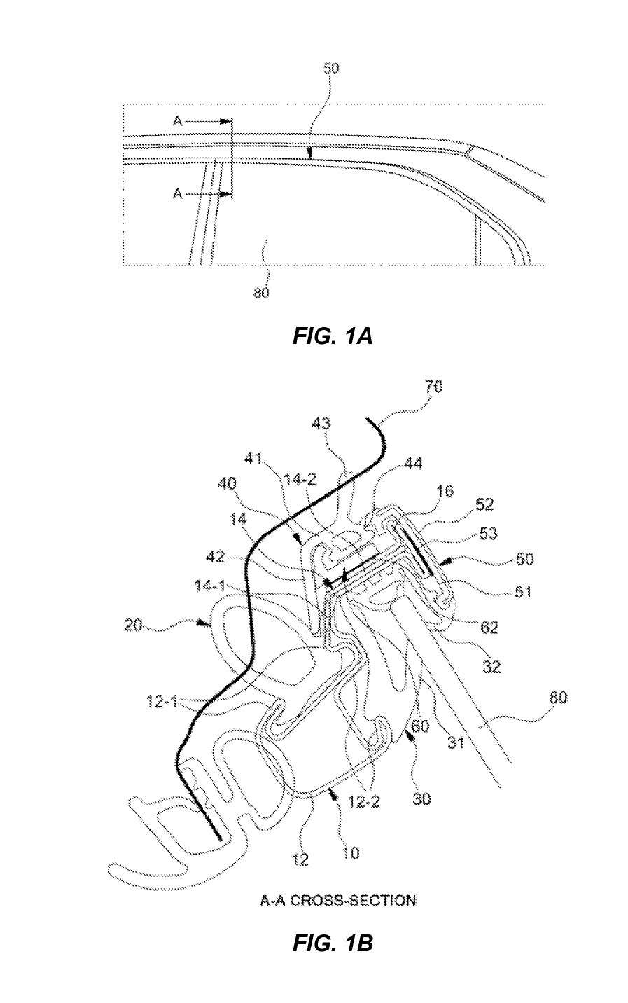

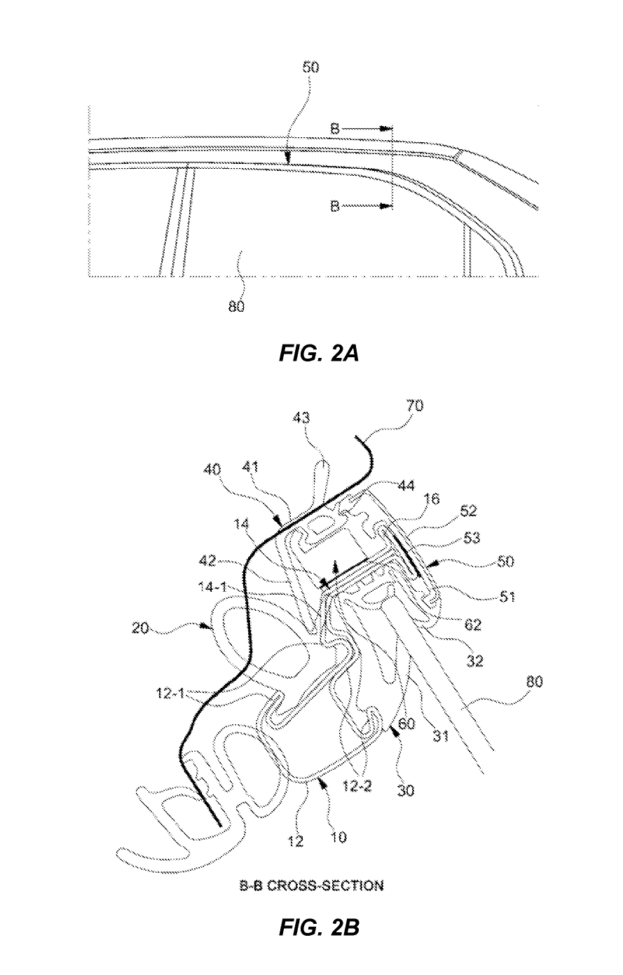

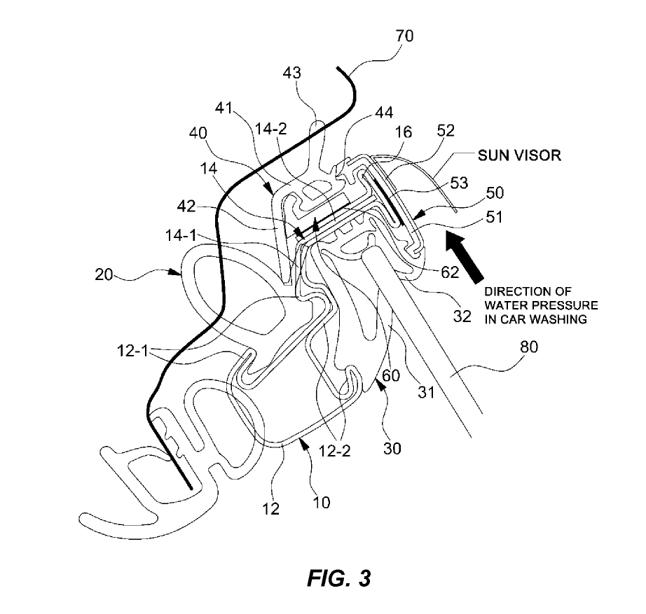

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

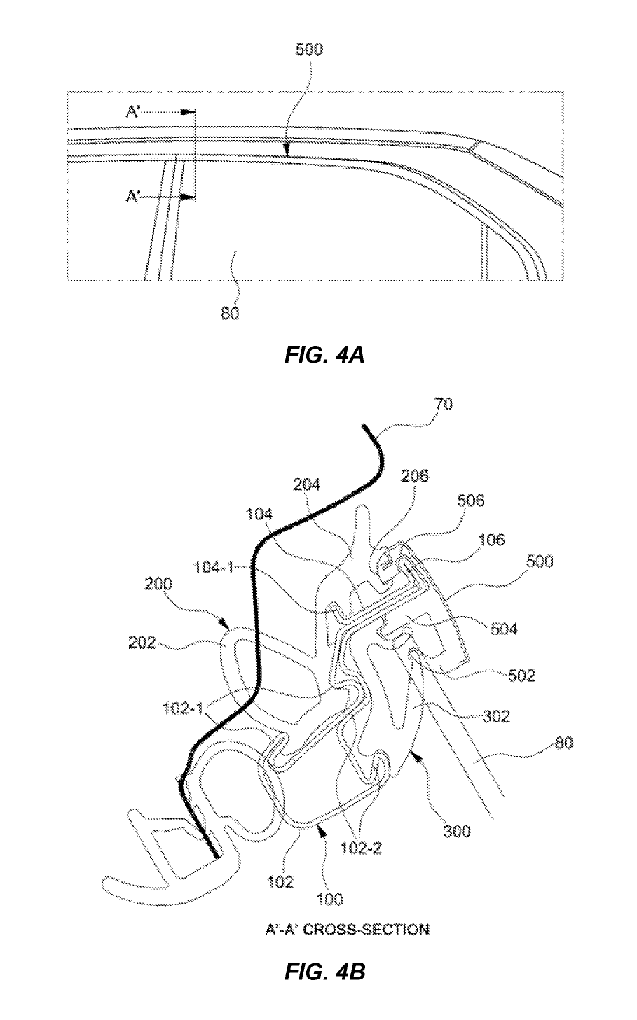

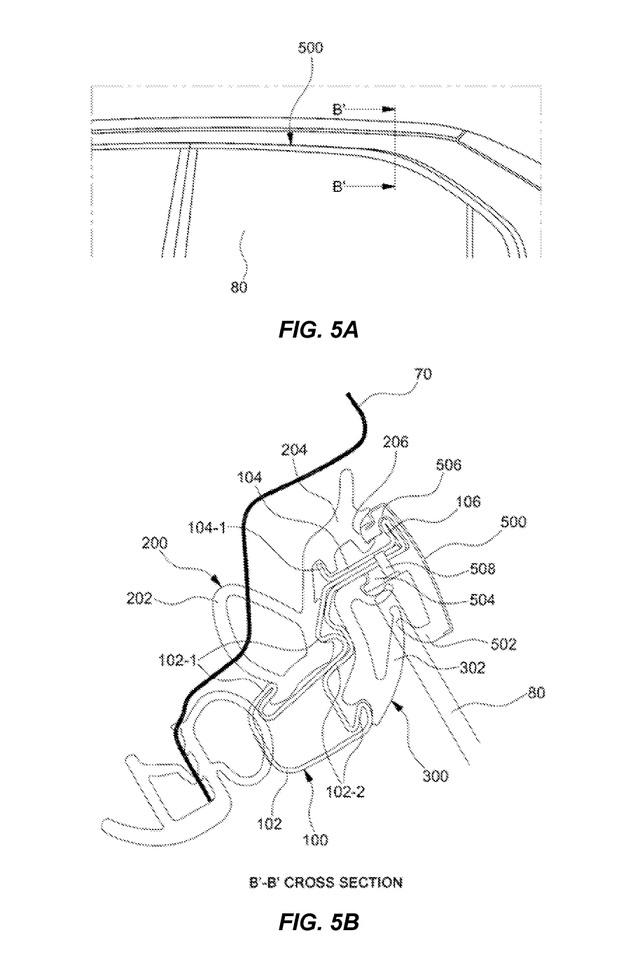

In the accompanying drawings, FIG. 4A and FIG. 4B are cross-sectional views illustrating the front portion of a door frame molding device according to the present invention and FIG. 5A and FIG. 5B are cross-sectional views illustrating the rear portion of the door frame molding device according to the present invention.

In FIG. 4A, FIG. 4B, FIG. 5A and FIG. 5B, the reference numeral 100 indicates a door frame.

The door frame 100, which is manufactured by bending of folding a sheet of frame in a single unit having a predetermined shape with a roll mold, is composed of an inner support 102 formed with a space therein by foaming, a connection support 104 extending from the outer upper end of the inner support 102 and horizontally arranged, and a variable frame molding support 106 vertically bending upward from the outer end of the connection support 104.

The connection support 104 and the variable frame molding support 106 of the door frame 100 make an L-shaped cross-section.

First bending portions 102-1 are formed at the inner and outer ends of the top of the inner support 102 of the door frame 100 to form a groove in which an end of an integral weather strip 200 is fitted and second bending portions 102-2 are formed at the upper end and the lower end of the outer side of the inner support 102 to form a groove in which a run channel is fitted.

A support protrusion 104-1 supporting the other end of the integral weather strip 200 is formed on the top inside the connection support 104.

The integral weather strip 200 for waterproofing and airtightness in contact with a car body panel 70, a run channel 300 in which the upper end of a door glass 80 is inserted without a shock when it is moved up, and a variable frame molding 500 that is a kind of ornament for the external appearance are compactly mounted on the door frame 100.

The integral weather strip 200, which is disposed on the inner support 102 and the connection support 104 of the door frame 100, is manufactured by forming a hollow door weather strip part 202 being in close contact with the inner side of the car body panel 70 with a parting weather strip part 204 being in close contact with the outer side of the car body panel 70 into a signal unit.

A support groove 206 in which the upper end of the variable frame molding 500 is inserted and supported is formed on the outer side of the parting weather strip part 204 of the integral weather strip 200.

Accordingly, the door weather strip part 202 of the integral weather strip 200 is inserted in the groove formed by the first bending portions 102-1 of the inner support 102 of the door frame 100 and the parting weather strip part 204 is supported by the support protrusion 104-1 integrally formed on the top inside the connection support 104.

The run channel 300 has only an inner glass run 302 supporting the inner side of a glass and is in close contact with the outer side and the bottom of the inner support 102 of the door frame 100, with its lower end inserted and supported in the groove formed by the second bending portions 102-2 of the inner support 102.

The variable frame molding 500 is mounted, covering the variable frame molding support 106 of the door frame 100. The variable frame molding 500 is fastened to the bottom of the connection support 104, in close contact with the variable frame molding support 106 of the door frame 100.

The variable frame molding 500 is composed of an insert injection-molded body and an ornament frame (for example, an SUS plate) integrally injection-molded on the outer side of the insert injection-molded body.

According to various embodiments of the present invention, the upper end of the variable frame molding 500 that is the upper part over the connection support 104 of the door frame 100 has the same vertical width at the front portion and the rear portion, while the lower end of the variable frame molding 500 that is the lower part has a vertical width that increases, as it goes rearward.

A fitting groove 506 in which the variable frame molding support 106 of the door frame 100 is fitted is formed on the inner side of the top of the variable frame molding 500.

In particular, a fastening protrusion 540 that is fastened by a clip 508 in close contact with the bottom of the connection support 104 of the door frame 100 is integrally formed on the inner side of the variable frame molding 500, and preferably, the fastening protrusion 504 increases in thickness, as it goes from the front portion to the rear portion, in proportion to the width of the lower end of the variable frame molding 500 which increases, as it goes from the front portion to the rear portion.

Accordingly, by fastening the clip 508 with the fastening protrusion 504 of the variable frame molding 500 in close contact with bottom of the connection support 104 of the door frame 100, the variable frame molding 500 is mounted on the door frame 100.

At the same time, by inserting the variable frame molding support 106 of the door frame 100 into the fitting groove 506 formed on the inner side of the top of the variable frame molding 500, when mounting the variable frame molding 500, the variable frame molding 500 is more strongly combined with the door frame.

By inserting and supporting the upper end of the variable frame molding 500 in the support groove 206 formed on the outer side of the parting weather strip 204 of the integral weather strip 200, when mounting the variable frame molding 500, the variable frame molding 500 can be more firmly combined.

Since the variable frame molding 500 is more firmly combined, as described above, coming-off of a variable frame molding due to water pressure in car washing in the related art can be prevented.

In particular, the upper end of the variable frame molding 500 has a constant vertical width and the lower end has a vertical width that increases, as it goes rearward, and the fastening protrusion 504 of the variable frame molding 500 increases in thickness, as it goes from the front portion to the rear portion, in proportion to the width of the lower end of the variable frame molding 500 which increases, as it goes from the front portion to the rear portion, such that an integral weather strip manufactured by integrally forming a door weather strip part and a parting weather strip part in a signal unit can be used, and thus, the number of parts can be reduced.

Since the fastening protrusion 504 of the variable frame molding 500 increases in vertical thickness, as it goes from the front portion to the rear portion, in proportion to the width of the lower end of the variable frame molding 500 which increases, as it goes from the front portion to the rear portion, the front upper end and the rear upper end of the glass 80 can uniformly come in contact with the bottom of the fastening protrusion 504, when it is moved up, so the upward movement distances of the front and the rear of the glass 80 can be kept uniform.

On the other hand, an outer glass run 502 supporting the outer side of the glass 80 is integrally formed on the inner side of the bottom of the variable frame molding 500.

That is, an outer glass run other than the inner glass run 302 was integrally formed in the run channel 300 in the related art, but the outer glass run 502 is formed on the inner side of the bottom of the variable frame molding 500 in the present invention.

Accordingly, the variable frame molding 500 is firmly mounted, as described above, that is, the variable frame molding 500 is firmly mounted and the outer glass run 502 keeps its position, so it is possible to prevent the phenomenon that an outer glass run integrally formed in a run channel from is pulled up and the supporting force that brings the outer glass run in close contact with a glass decreases.

For convenience in explanation and accurate definition in the appended claims, the terms “upper”, “lower”, “inner” and “outer” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the claims appended hereto and their equivalents.

What is claimed is:

1. An automotive door molding device, comprising:
a door frame composed of an inner support formed with a space therein by foaming, a connection support extending from an outer upper end of the inner support and horizontally arranged, and a variable frame molding support vertically bending upward from an outer end of the connection support;
an integral weather strip disposed on the inner support and the connection support of the door frame;
a run channel having an inner glass run supporting an inner side of a glass and disposed on an outer side and a bottom of the inner support of the door frame; and
a variable frame molding fastened to a bottom of the connection support, in close contact with the variable frame molding support of the door frame.

2. The device of claim 1, wherein the integral weather strip is manufactured by forming a hollow door weather strip part being in close contact with an inner side of the car body panel with a parting weather strip part being in close contact with an outer side of the car body panel into a signal unit.

3. The device of claim 2, wherein a support groove in which the upper end of the variable frame molding is inserted and supported is formed on an outer side of the parting weather strip part of the integral weather strip.

4. The device of claim 1, wherein the variable frame molding has an upper end that is an upper part over the connection support of the door frame having a same vertical width at a front portion and a rear portion of the variable frame molding, and a lower end that is a lower part having a vertical width that increases rearward.

5. The device of claim 1, wherein a fastening protrusion that is fastened by a clip in close contact with the bottom of the connection support of the door frame is integrally formed on an inner side of the variable frame molding.

6. The device of claim 5, wherein the fastening protrusion increases in thickness, as it goes from the front portion to the rear portion, in proportion to the width of the lower end of the variable frame molding which increases, as it goes from the front portion to the rear portion.

7. The device of claim 1, wherein an outer glass run supporting an outer side of a glass is integrally formed on an inner side of a bottom of the variable frame molding.

8. The device of claim 1, wherein a fitting groove in which the variable frame molding support of the door frame is fitted is formed on an inner side of a top of the variable frame molding.

9. The device of claim 1, wherein a support protrusion supporting an end of the integral weather strip is integrally formed on a top inside the connection support.

10. The device of claim 4, wherein a fastening protrusion that is fastened by a clip in close contact with the bottom of the connection support of the door frame is integrally formed on an inner side of the variable frame molding.

11. The device of claim 4, wherein an outer glass run supporting an outer side of a glass is integrally formed on an inner side of a bottom of the variable frame molding.

12. The device of claim 4, wherein a fitting groove in which the variable frame molding support of the door frame is fitted is formed on an inner side of a top of the variable frame molding.
